(19) United States
(12) Patent Application Publication
(10) Pub. No.: US 2011/0184092 A1
(43) Pub. Date: Jul. 28, 2011

(54) EPOXY RESIN COMPOSITION

(75) Inventors: Stéphane SCHAAL, Sierentz (FR); Cherif Ghoul, Mulhouse (FR); Patricia Gonzalez, Zaragoza (ES)

(73) Assignee: ABB RESEARCH LTD, Zurich (CH)

(21) Appl. No.: 13/051,796

(22) Filed: Mar. 18, 2011

Related U.S. Application Data
(63) Continuation of application No. PCT/EP2008/062546, filed on Sep. 19, 2008.

(51) Int. Cl. C08L 63/02; B29C 39/38

(52) U.S. Cl. 523/466; 264/241

(57) ABSTRACT

Curable epoxy resin composition, which is suitable for the production of electrical insulation systems for low, medium and high voltage applications, including at least an epoxy resin, a hardener, a mineral filler material, and optionally further additives, wherein (i) the epoxy resin component is a diglycidylether of bisphenol A (DGEBA); (ii) the hardener includes methyltetrahydrophthalic anhydride (MTHPA) and polypropylene glycol (PPG), wherein (iii) the average molecular weight of the polypropylene glycol (PPG) is within the range of about 300 to about 510 Dalton; and (iv) the molar ratio of methyltetrahydrophthalic anhydride (MTHPA) to polypropylene glycol (PPG) is within the range of about 9:1 to 19:1. A method of making the epoxy resin composition and electrical articles made therefrom are also provided.

### RELATED APPLICATION

This application claims priority as a continuation application under 35 U.S.C. §120 to PCT/EP2008/062546 filed as an International Application on Sep. 19, 2008 designating the U.S., the entire content of which is hereby incorporated by reference in its entirety.

### FIELD

The present disclosure relates to an epoxy resin composition suitable for the production of electrical insulation systems with improved properties, and to electrical articles including the electrical insulation system.

### BACKGROUND INFORMATION

Epoxy resin compositions present a number of advantages over other thermosetting polymers. For example, epoxy resin compositions have a comparatively low price, are easy to process and, after curing, yield electrical insulator systems with good electric and mechanical properties. Epoxy resin compositions, therefore, are widely used in the production of electrical insulation systems. Current commercially available epoxy resin compositions which, on curing, yield electrical insulation systems generally include the following components: an epoxy resin, a pre-reacted hardener and a curing catalyst. The pre-reacted hardener, for example methyltetrahydrophthalic anhydride (MTHPA) pre-reacted with polypropylene glycol (PPG), generally leads to an increase in the viscosity of the uncured epoxy resin composition which has a negative effect on its processability and does not allow the electrical insulation system made therefrom to have a high filler content. To ensure a good processability of the uncured epoxy resin composition, for example, in the case of a high filler content, a low viscosity epoxy resin component is generally used. This is achieved for example by substituting diglycidylether of bisphenol A (DGEBA) either partially or totally by diglycidylether of bisphenol F (DGEBF). This, however, has the drawback of including an additional step of mixing the two components DGEBA and DGEBF for producing the starting composition and further is more expensive than using the diglycidylether of bisphenol A (DGEBA) as the only epoxy resin component.

### SUMMARY

An exemplary embodiment of the present disclosure provides a curable epoxy resin composition, which is suitable for the production of electrical insulation systems for low, medium and high voltage applications, including at least: an epoxy resin, a hardener, a mineral filler material, and optionally further additives. The epoxy resin component can be a diglycidylether of bis phenol A (DGEBA). The hardener can include methyltetrahydrophthalic anhydride (MTHPA) and polypropylene glycol (PPG). The average molecular weight of the polypropylene glycol (PPG) is within the range of about 300 to about 510 Dalton. The molar ratio of methyltetrahydrophthalic anhydride (MTHPA) to polypropylene glycol (PPG) is within the range of about 9:1 to 19:1.

An exemplary embodiment of the present disclosure provides a method of producing a curable epoxy resin composition, wherein in a first step the hardener components or a part of the hardener components including MTHPA and PPG are pre-reacted together at elevated temperature, and subsequently mixed with all the other components of the uncured epoxy resin composition. An exemplary embodiment of the present disclosure provides an electrical article including an insulation system, which includes a curable epoxy resin composition.

An exemplary embodiment of the present disclosure provides a process for making shaped articles using a composition. The exemplary process includes the steps of: (a) pre-heating a curable liquid epoxy resin composition including diglycidyl ether of bisphenol A (DGEBA), an anhydride hardener including methyltetrahydrophthalic anhydride (MTHPA) and polypropylene glycol (PPG), a mineral filler, and optionally further additives; (b) transferring the composition into a pre-heated mold; (c) curing the composition at elevated temperature for a time sufficient to obtain a shaped article with an infusible cross-linked structure; and (d) optionally post curing the obtained shaped article.

### DETAILED DESCRIPTION

An exemplary embodiment of the present disclosure relates to a curable epoxy resin composition, which may be suitable for the production of electrical insulation systems for low, medium and high voltage applications, including at least: an epoxy resin, a hardener, a mineral filler material, and optionally further additives, wherein:

(i) the epoxy resin component is a diglycidylether of bisphenol A (DGEBA);
(ii) the hardener includes methyltetrahydrophthalic anhydride (MTHPA) and polypropylene glycol (PPG), wherein
(iii) the average molecular weight of the polypropylene glycol (PPG) is within the range of about 300 to about 510 Dalton; and
(iv) the molar ratio of methyltetrahydrophthalic anhydride (MTHPA) to polypropylene glycol (PPG) is within the range of about 9:1 to 19:1.

An exemplary embodiment of the present disclosure further refers to a method of producing the curable epoxy resin composition. An exemplary embodiment of the present disclosure further refers to the use of the curable epoxy resin composition for the production of insulation systems in electrical articles.

An exemplary embodiment of the present disclosure further refers to the cured epoxy resin composition, which may be present in the form of an electrical insulation system, resp. in the form of an electrical insulator.

An exemplary embodiment of the present disclosure further refers to the electrical articles including an electrical insulation system made according to an exemplary embodiment of the present disclosure.

Diglycidylether of bisphenol A (DGEBA) is commercially available as an epoxy resin component, e.g. as Epilox A19-00 (Leuna Harze GmbH.) or similar products. DGEBA is the diglycidylether of 2,2-bis-(4-hydroxyphenyl)-pro-pane (bisphenol A) and is represented as a monomeric compound by the following formula (I):

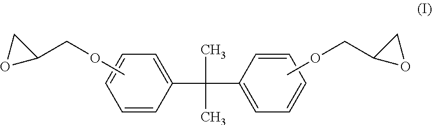

wherein the glycidyl ether substituent each time preferably is in the paraposition.

Diglycidylether of bisphenol A (DGEBA) as used in an exemplary embodiment of the present disclosure has an epoxy value (equiv./kg) of, for example, at least three, for example, at least four and, for example, at about five or higher, for example about 5.0 to 6.1.

The hardener as used in an exemplary embodiment of the present disclosure includes methyltetrahydrophthalic anhydride (MTHPA) and polypropylene glycol (PPG). MTHPA is commercially available and exists in different forms, e.g. as 4-methyl-1,2,3,6-tetrahydrophthalic anhydride or e.g. as 4-methyl-3,4,5,6-tetrahydrophthalic anhydride. Although the different forms may not be critical for the application in the present disclosure, 4-methyl-1,2,3,6-tetrahydrophthalic anhydride and 4-methyl-3,4,5,6-tetrahydrophthalic anhydride are exemplary compounds to be used. Methyltetrahydrophthalic anhydride (MTHPA) is often supplied commercially as a mixture containing MTHPA isomers as the main component, together with other anhydrides, such as tetrahydrophthalic anhydride (THPA), methylhexahydrophthalic anhydride (MHHPA) and/or phthalic anhydride (PA). The expression “methyltetrahydrophthalic anhydride (MTHPA)” as used herein includes such mixtures within its scope. Such mixtures may also be used within the scope of the present disclosure. The content of MTHPA within such a mixture is, for example, at least 50% by weight, for example, at least 60% by weight, for example, at least 70% by weight, for example, at least 80% by weight, and, for example, at least 90% by weight, calculated to the total weight of the anhydride mixture.

Polypropylene glycol (PPG) with an average molecular weight within the range of about 300 to about 510 Dalton is an exemplary embodiment. For example, the average molecular weight may be within the range of about 350 to about 460 Dalton, for example, within the range of about 370 to about 440 Dalton, for example, at about 400 Dalton.

The value of 300 Dalton corresponds to an average polymerization degree of the propylene glycol of about 4; the value of 370 Dalton corresponds to an average polymerization degree of the propylene glycol of about 5; the value of 440 Dalton corresponds to an average polymerization degree of the propylene glycol of about 6; and the value of 510 Dalton corresponds to an average polymerization degree of the propylene glycol of about 7.

The reactive groups of the hardener components on curing the epoxy resin composition react with the epoxide groups of the epoxy resin component, e.g., the reactive groups of methyltetrahydrophthalic anhydride (MTHPA) and the optionally present other anhydrides as mentioned above as well as the hydroxyl groups of the polypropylene glycol (PPG) can react with the epoxide groups of the epoxy resin component. Further, the hydroxyl groups of PPG may react with the reactive groups of MTHPA. It is therefore possible to pre-react the PPG with the MTHPA and then combine the pre-reacted hardener with the epoxy resin component, which is an exemplary embodiment of the present disclosure.

The optional hardener may be, for example, used in concentrations within the range of 0.8 to 1.2, for example, within the range of 0.9 to 1.1, equivalents of hardening groups present, e.g. one anhydride group resp. hydroxyl group per 1 epoxy equivalent.

The molar ratio of methyltetrahydrophthalic anhydride (MTHPA) to polypropylene glycol (PPG) may be within the range of about 9:1 to 19:1, for example, within the range of about 10:1 to 16:1, for example, within the range of about 11:1 to 15:1, and for example, within the range of about 12:1 to 14:1.

The inorganic filler may be present in the epoxy resin composition, depending on the final application of the epoxy resin composition, for example, within the range of about 50% by weight to about 80% by weight, for example, within the range of about 60% by weight to about 75% by weight, and for example, at about 65% by weight, calculated to the total weight of the epoxy resin composition.

The mineral filler may have an average grain size for the use in electrical insulation systems and may be, for example, within the range of 10 micron up to 3 mm. An exemplary embodiment includes an average grain size (at least 50% of the grains) within the range of about 1 μm to 300 μm, for example, from 5 μm to 100 μm, or a selected mixture of such average grain sizes. An exemplary embodiment includes a filler material with a high surface area.

The mineral filler may be, for example, selected from conventional filler materials as are generally used as fillers in electrical insulations. For example, the filler is selected from the group of filler materials including mineral, i.e. inorganic, oxides, inorganic hydroxides and inorganic oxyhydroxides, for example, silica, quartz, known silicates, aluminium oxide, aluminium trihydrate [ATH], titanium oxide or dolomite [CaMg(CO₃)₂], metal nitrides, such as silicon nitride, boron nitride and aluminium nitride or metal carbides, such as silicon carbide. An exemplary embodiment includes silica and quartz, for example, silica flour, with an average grain size within the range as given above and with a minimum SiO₂-content of about 95-98% by weight.

The filler material may optionally be coated for example with a silane or a siloxane known for coating filler materials, e.g. dimethylsiloxanes which may be cross linked, or other known coating materials.

The filler material optionally may be present in a “porous” form. As a porous filler material, which optionally may be coated, is understood, that the density of the filler material may be within the range of 60% to 80%, compared to the real density of the non-porous filler material. Such porous filler materials have a higher total surface than the non-porous material. The surface may be, for example, higher than 20 m²/g (BET m²/g) and for example, higher than 30 m²/g (BET) and for example, is within the range of 30 m²/g (BET) to 100 m²/g (BET), for example within the range of 40 m²/g (BET) to 60 m²/g (BET).

As optional additives the composition may include further a curing agent (catalyst) for enhancing the polymerization of the epoxy resin with the hardener. Further additives may be selected from hydrophobic compounds including silicones, wetting/dispersing agents, plasticizers, antioxidants, light absorbers, pigments, flame retardants, fibers and other additives generally used in electrical applications.

Exemplary curing agents (catalyst) include tertiary amines, such as benzyldimethylamine or amine-complexes such as complexes of tertiary amines with boron trichloride or boron trifluoride; urea derivatives, such as N-4-chlorophenyl-N′,N′-dimethylurea (Monuron); optionally substituted imidazoles such as imidazole or 2-phenyl-imidazole. Exemplary curing agents include tertiary amines, for example, 1-substituted imidazole and/or N,N-dimethylbenzylamine, such as 1-alkyl imidazoles which may or may not be substituted also in the 2-position, such as 1-methyl imidazole or 1-isopropyl-2-methyl imidazole. Exemplary curing agents include 1-methyl imidazole. The amount of catalyst used may be, for example, a concentration of less than 5% by weight, for example, about 0.01 to 2.5%, for example, about 0.05% to 2% by weight, for example, about 0.05% to 1% by weight, calculated to the weight of the DGEBA present within the composition.

Suitable hydrophobic compound or a mixture of such compounds, for example, for improving the self-healing properties of the electrical insulator may be selected from the group including flowable fluorinated or chlorinated hydrocarbons which contain —CH₂-units, —CHF-units, —CF₂-units, —CF₃-units, —CHCl-units, —C(Cl)-2-units, —C(Cl)-3-units, or mixtures thereof; or a cyclic, linear or branched flowable organopolysiloxane. Such compounds may be in encapsulated form.

An exemplary embodiment of the hydrophobic compound may have a viscosity in the range from 50 cSt to 10,000 cSt, for example, in the range from 100 cSt to 10,000 cSt, for example, in the range from 500 cSt to 3000 cSt, measured in accordance with DIN 53 019 at 20° C.

Suitable polysiloxanes may be linear, branched, cross-linked or cyclic. For example, the polysiloxanes may be composed of—[Si(R)(R)O]-groups, wherein R independently of each other is an unsubstituted or substituted, preferably fluorinated, alkyl radical having from 1 to 4 carbon atoms, or phenyl, preferably methyl, and wherein the substituent R may carry reactive groups, such as hydroxyl or epoxy groups. Non-cyclic siloxane compounds may have, on average, about from 20 to 5000, for example, 50-2000, —[Si(R)(R)O]-groups. Exemplary cyclic siloxane compounds are those including 4-12, and for example, 4-8, —[Si(R)(R)O]-units.

The hydrophobic compound may be added to the epoxy resin composition, for example, in an amount of from 0.1% to 10%, for example, in an amount of from 0.25% to 5% by weight, for example in an amount of from 0.25% to 3% by weight, calculated to the weight of the weight of DGEBA present.

An exemplary embodiment of the present disclosure refers to a method of producing the curable epoxy resin composition. According to an exemplary embodiment of the present disclosure the curable epoxy resin composition may be made by simply mixing all the components, e.g., the epoxy resin, the hardener including methyltetrahydrophthalic anhydride (MTHPA) and polypropylene glycol (PPG) or a pre-polymer thereof, the mineral filler material, and any further additive which optionally may be present, optionally under vacuum, in any desired sequence.

For example, in a first step, the hardener components or a part of the hardener components including methyltetrahydrophthalic anhydride (MTHPA) and polypropylene glycol (PPG) are pre-reacted together at elevated temperature, e.g. within a temperature range of about 30° C. to 90° C., for example, within the range of 40° C. to 80° C., yielding a pre-reacted hardener. This pre-reacted hardener is subsequently mixed with all the other components of the uncured epoxy resin composition, e.g., the epoxy resin, any remaining methyltetrahydrophthalic anhydride (MTHPA) and/or polypropylene glycol (PPG), the mineral filler, and any further additive which optionally may be present, optionally under vacuum, in any desired sequence.

For example, the hardener, the curing agent, the mineral filler, and any further additive, may be separately added and intensively mixed with the epoxy resin component to finally yield the uncured epoxy resin composition, for example, under vacuum.

The uncured epoxy resin composition may be cured, at a temperature, for example, within the range of 50° C. to 280° C., for example, within the range of 100° C. to 200° C., for example, within the range of 100° C. to 170° C., and for example, at about 130° C. and during a curing time within the range of about 2 hours to about 10 hours. Curing generally is possible also at lower temperatures, whereby at lower temperatures complete curing may last up to several days depending on the catalyst present and its concentration.

Suitable processes for shaping the cured epoxy resin compositions of exemplary embodiments of the disclosure are for example the APG (Automated Pressure Gelation) Process and the Vacuum Casting Process. Such processes typically include a curing step in the mold for a time sufficient to shape the epoxy resin composition into its final infusible three dimensional structure, typically up to ten hours, and a post-curing step of the demolded article at elevated temperature to develop the ultimate physical and mechanical properties of the cured epoxy resin composition. Such a post-curing step may take, depending on the shape and size of the article, up to thirty hours.

A process for making shaped articles using a composition according to an exemplary embodiment of the present disclosure includes the steps of:

(a) pre-heating a curable liquid epoxy resin composition including diglycidyl ether of bisphenol A (DGEBA) as described above, an anhydride hardener including methyltetrahydrophthalic anhydride (MTHPA) and polypropylene glycol (PPG) as described above, a mineral filler, and optionally further additives;
(b) transferring the composition into a pre-heated mold, for example, under vacuum;
(c) curing the composition at elevated temperature for a time sufficient to obtain a shaped article with an infusible cross-linked structure; and
(d) optionally post curing the obtained shaped article.

Exemplary uses of the insulation systems produced according to the present disclosure are dry-type transformers, for example. cast coils for dry type distribution transformers, for example, vacuum cast dry distribution transformers, which within the resin structure contain electrical conductors; high-voltage insulations for indoor use, like breakers or switchgear applications; high voltage and medium voltage bushings; as long-rod, composite and cap-type insulators, and also for base insulators in the medium-voltage sector, in the production of insulators associated with outdoor power switches, measuring transducers, leadthroughs, and overvoltage protectors, in switchgear constructions, in power switches, and electrical machines, as coating materials for Transistors and other semiconductor elements and/or to impregnate electrical components.

The present disclosure further refers to the electrical articles containing an electrical insulation system according to the present disclosure.

The following examples illustrate the disclosure without limiting the scope of the disclosure. Suppliers are named for different components, whereby of course the disclosure is not bound to the compounds supplied by the named suppliers.

### Examples 1-4 and Comparative Example

### General Procedures

The silica filler was dried overnight at 160° C. and cooled down to 65° C. The epoxy resin and the hardener were preheated separately to 75° C. The mixing of all components was carried out for 30 minutes in small aluminum buckets with an overhead stirrer. Degassing was performed at 75° C. and 1 mbar before and after casting. Plates were cast (4 mm thickness) and cured at 140° C.

Tensile strength tests were carried out on a Zwick-Roell 100 according to the standard ISO 527 at room temperature. The extremities of dumbbell shaped samples were gripped in a tensile test machine and were elongated until rupture at a constant rate of 2 mm/min. The elongation and the force were recorded. Young's modulus, tensile strength and elongation at break were then calculated.

Viscosity was measured on a Bohlin CVO 75 rheometer in a plate-plate geometry (40 mm diameter, 500 micron gap) in oscillation mode (1 Hz, 50% strain) at 75° C.

### Preparation of the Comparative Example

A commercial system consisting of a DGEBA/DGEBF mixture supplied by Hexion under the commercial name Epikote EPR 845 with an epoxy value of 4.9-5.1 equivalent/100 g, a pre-reacted hardener supplied by Hexion under the commercial name Epikure EPH 845 (modified MTHPA), the catalyst EPC 845 supplied by Hexion (a modified tertiary amine modifier) and silica flour Millisil W12 supplied by Quarzwerke were intensively mixed together under the conditions as described above and degassed before and after casting. Plates were cast (4 mm thickness) and cured at 140° C. Quantities were used as given in Table 1.

TABLE 1
(Composition of the Comparative Example)

| | | Pre-reacted | | |
|---|---|---|---|---|
| | DGEBA/DGEBF | hardener | Catalyst | Filler, W12 |
| Parts by | 100 | 82 | 2 | 335 |
| weight: | | | | |

DGEBA/DGEBF: Epikote EPR 845 (Hexion)
Pre-reacted hardener: Epikure EPH 845 (Hexion)
Catalyst: EPC 845 (Hexion)
Filler, Millisil W12 (Quarzwerke)

### Preparation of the Examples 1-4

Step (A): 70 parts of methyltetrahydrophthalic anhydride (MTHPA) and 12-18 parts of polypropylene glycol (PPG) were mixed together in a vessel under vacuum at a temperature of 75° C., for about 90 minutes with parts of the silica filler Millisil W12 and the catalyst DY070 (Huntsman).

Step (A′): in parallel and under the same mixing conditions as described in Step (A), DGEBA (diglycidylether of bisphenol A) (Epilox A19-00 supplied by Leuna Harze) and the rest of the silica flour Millisil W12 (Quarzwerke) were intensively mixed together under the conditions as described above and degassed before and after casting.

Step (B) the materials obtained from steps (A) and (A′) were mixed with a static mixer and further degassed. Plates were cast under vacuum (4 mm thickness) and cured for at 140° C. Quantities were used as given in Table 2.

TABLE 2
(Composition of Examples 1-4, given in parts by weight)

| | Example | Example | Example | Example |
|---|---|---|---|---|
| | 1 | 2 | 3 | 4 |
| DGEBA | 100 | 100 | 100 | 100 |
| Pre-reacted | 82 | 84 | 86 | 88 |
| hardener | | | | |
| or separate | 70 + 12 | 70 + 14 | 70 + 16 | 70 + 18 |
| components: | | | | |
| MTHPA + | | | | |
| PPG 400 | | | | |
| Catalyst | 1.0 | 1.0 | 1.0 | 1.0 |
| Filler, W12 | 335 | 335 | 335 | 335 |

DGEBA: Epilox A19-00 (Leuna Harze)
Pre-reacted hardener: as obtained in Step (A)
Catalyst: 1-methyl imidazole, DY070 (Huntsman)
Filler, silica flour Millisil W12 (Quarzwerke)

Comparison of the Reference with Examples 1-4

The properties of the commercial Reference were compared with the properties of the Examples 1-4, prepared according to the present disclosure. Comparisons focused on the viscosity and mechanical properties.

The properties obtained from the products of Examples 1-4 are equal or better than the properties as obtained from the commercial Reference product.

The experimental results are shown in Table 3.

TABLE 3

| | Refer- | Example | Example | Example | Example |
|---|---|---|---|---|---|
| | ence | 1 | 2 | 3 | 4 |
| Thermal | | | | | |
| properties: | | | | | |
| Tg (° C.) | 85 | 95 | 90 | 86 | 85 |
| Mechanical | | | | | |
| Properties: | | | | | |
| Young's | 12.4 | 11.4 | 11.8 | 11.9 | 10.9 |
| modulus (GPa) | | | | | |
| Tensile | 79.9 | 76.8 | 81.1 | 86.4 | 80.0 |
| strength (MPa) | | | | | |
| Elongation at | 0.97 | 0.89 | 0.98 | 1.19 | 1.05 |
| break (%) | | | | | |
| Processing: | | | | | |
| Viscosity | 950 | 900 | 850 | 750 | 700 |
| (mPa · s) | | | | | |
| at 75° C. | | | | | |

### Discussion

One observes that the use of an increased amount of PPG within the given limits leads to a decrease of the Tg (glass-transition temperature) and an increase of the elongation at break. The formulations according to an exemplary embodiment of the present disclosure with PPG contents above 12 phr exhibit an overall balance of properties that is equal or superior to the reference and fulfills the requirements for an easy to process composition as defined in the introduction of the description herein above.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Curable epoxy resin composition, which is suitable for the production of electrical insulation systems for low, medium and high voltage applications, comprising at least: an epoxy resin, a hardener, a mineral filler material, and optionally further additives, wherein:
(i) the epoxy resin component is a diglycidylether of bis phenol A (DGEBA);
(ii) the hardener comprises methyltetrahydrophthalic anhydride (MTHPA) and polypropylene glycol (PPG), wherein
(iii) the average molecular weight of the polypropylene glycol (PPG) is within the range of about 300 to about 510 Dalton; and
(iv) the molar ratio of methyltetrahydrophthalic anhydride (MTHPA) to polypropylene glycol (PPG) is within the range of about 9:1 to 19:1.

2. Composition according to claim 1, wherein the diglycidylether of bisphenol A (DGEBA) has an epoxy value of at least three (equiv./kg).

3. Composition according to claim 1, wherein diglycidylether of bisphenol A (DGEBA) has an epoxy value of at least four (equiv./kg).

4. Composition according to claim 1, wherein MTHPA is 4-methyl-1,2,3,6-tetrahydrophthalic anhydride and 4-methyl-3,4,5,6-tetrahydrophthalic anhydride.

5. Composition according to claim 1, wherein MTHPA is a mixture containing MTHPA isomers as the main component together with other anhydrides selected from tetrahydrophthalic anhydride (THPA), methylhexahydrophthalic anhydride (MHHPA) and phthalic anhydride (PA).

6. Composition according to claim 5, wherein the content of MTHPA within the mixture is at least 50% by weight, calculated to the total weight of the anhydride mixture.

7. Composition according to claim 1, wherein polypropylene glycol (PPG) has an average molecular weight within the range of about 300 to about 510 Dalton, preferably within the range of about 350 to about 460 Dalton.

8. Composition according to claim 1, wherein PPG is pre-reacted with the MTHPA.

9. Composition according to claim 1, wherein hardener is used in concentrations within the range of 0.8 to 1.2, equivalents of hardening groups present.

10. Composition according to claim 1, wherein the molar ratio of MTHPA to PPG is within the range of about 9:1 to 19:1.

11. Composition according to claim 1, wherein the composition further comprises at least one additive selected from curing agents, hydrophobic compounds, wetting/dispersing agents, plasticizers, antioxidants, light absorbers, pigments, flame retardants and fibers.

12. Method of producing a curable epoxy resin composition according to claim 1, wherein in a first step the hardener components or a part of the hardener components comprising MTHPA and PPG are pre-reacted together at elevated temperature, and subsequently mixed with all the other components of the uncured epoxy resin composition.

13. Method according to claim 12, wherein the pre-reacting together is within a temperature range of about 30° C. to 90° C.

14. An electrical article comprising an insulation system, the insulation system comprising a curable epoxy resin composition according to claim 1.

15. Method for the production of an insulation system according to claim 14, the method comprising curing the uncured epoxy resin composition is cured at a temperature within the range of 50° C. to 280° C. and during a curing time within the range of about 2 hours to about 10 hours.

16. Method according to claim 15, wherein the curing is under application of vacuum.

17. An electrical insulation system comprising an insulation system with a cured epoxy resin composition according to claim 15.

18. Process for making shaped articles using a composition according to claim 1, comprising the steps of:
(a) pre-heating a curable liquid epoxy resin composition comprising diglycidyl ether of bisphenol A (DGEBA), an anhydride hardener comprising methyltetrahydrophthalic anhydride (MTHPA) and polypropylene glycol (PPG), a mineral filler, and optionally further additives;
(b) transferring the composition into a pre-heated mold;
(c) curing the composition at elevated temperature for a time sufficient to obtain a shaped article with an infusible cross-linked structure; and
(d) optionally post curing the obtained shaped article.

19. Electrical articles comprising an electrical insulation system comprising an curable epoxy resin composition made according to the method of claim 12, the electrical article selected from the group of dry-type transformers, which within the resin structure contain electrical conductors; high-voltage insulations for indoor use; high voltage and medium voltage bushings.

20. Electrical articles comprising an electrical insulation system comprising a curable epoxy resin composition made according to the method of claim 12, the electrical insulation system selected from the group of long-rod, composite and cap-type insulators, base insulators in the medium-voltage sector, insulators for outdoor power switches.
